(19) United States
(12) Patent Application Publication
(10) Pub. No.: US 2011/0305540 A1
(43) Pub. Date: Dec. 15, 2011

(54) Impact-drivable screw with elastomer seal and tip highlight

(76) Inventor: W.C. Litzinger, Springdale, AR (US)

(21) Appl. No.: 13/068,955

(22) Filed: May 24, 2011

Related U.S. Application Data
(60) Provisional application No. 61/396,245, filed on May 24, 2010.

(51) Int. Cl. F16B 29/00; F16B 25/00

(52) U.S. Cl. 411/386

(57) ABSTRACT

An asymmetric thread impact drivable screw and clip for use with a power impact device for penetrating wood fibers while minimizing cut fibers. The screw includes an impact head and a conical shaped tip having a ballistic insertion angle at the ends of a shank. The shank defines asymmetrical threads with an insertion flank having a long side at a slide angle peaking at a crest supported by a catch flank positioned at a grip angle. Varying tool accepting recess are taught for the head along with multiple thread sections. A mushroom compaction thread section is also taught.

### CROSS-REFERENCE TO RELATED APPLICATIONS

This application claims priority to and is a continuation-in-part of U.S. Provisional Application Ser. No. 61/396,245 filed by Litzinger on May 24, 2010 entitled Impact-Drivable Screw With Elastomer Seal and Tip Highlight which is hereby incorporated by reference in its entirety.

### STATEMENT REGARDING FEDERALLY SPONSORED RESEARCH OR DEVELOPMENT

Not Applicable.

### REFERENCE TO A MICROFICHE APPENDIX

Not Applicable.

### RESERVATION OF RIGHTS

A portion of the disclosure of this patent document contains material which is subject to intellectual property rights such as but not limited to copyright, trademark, and/or trade dress protection. The owner has no objection to the facsimile reproduction by anyone of the patent document or the patent disclosure as it appears in the Patent and Trademark Office patent files or records but otherwise reserves all rights whatsoever.

### BACKGROUND OF THE INVENTION

1. Field of the Invention

The present invention relates to the field of sealing and placement of impact driveable screws. In particular, the present invention relates specifically to an elastomeric seal used in conjunction with an asymmetric thread screw having a highlighted ballistic point for use with impact drivers along with a high degree crest angle forming a long surface area slide flank and a short surface area grip flank to reduce fiber cutting during impact insertion of the screwnail. A secondary mushroom compaction thread is also disclosed.

2. Description of the Known Art

As will be appreciated by those skilled in the art, the use of hand driven nails and washers, or the use of screws with symmetrical thread screws, self drilling screws, and screws with cutting points have been known for an extended period of time. Present construction techniques use nails inserted into a washer that are hand driven or use only screws with a cutting or self tapping head that are rotated into a material to connect different materials together. This is very time consuming because of the extended time period it takes to add the washers to a nail or to rotate the screw into the material.

Other techniques use a combination of glue and regular nails in an attempt to achieve a similar holding power to the rotated screws. This creates a permanent attachment that cannot be disassembled. Similarly, the use of regular nails creates a strong bind that is difficult if not impossible to disassemble.

HITACHI has recently attempted impact driving screws with prior art type screw designs using a cutting point and a sharp angled thread on a wide thread pitch. These screws rip and tear the wood fibers during installation. See http://www.hitachipowertools.com for the limited information on their design.

Patents disclosing information relevant to screws include: U.S. Pat. No. 137,414, issued to Burdick on Apr. 1, 1873; U.S. Pat. No. 276,541, issued to Sloan on Apr. 24, 1883; U.S. Pat. No. 327,296, issued to McGinnis on Sep. 29, 1885; U.S. Pat. No. 373,074, issued to Jones on Nov. 15, 1887; U.S. Pat. No. 426,008, issued to Groff on Apr. 22, 1890; U.S. Pat. No. 471,179, issued to Jones on Mar. 22, 1892; U.S. Pat. No. 676,240, issued to Latty on Jun. 11, 1901; U.S. Pat. No. 1,326,910, issued to Butterfield on Jan. 6, 1920; U.S. Pat. No. 1,891,895, issued to Nagel on Dec. 20, 1932; U.S. Pat. No. 1,912,222, issued to Rosenberg on May 30, 1933; U.S. Pat. No. 1,953,592, issued to Deniston on Apr. 3, 1934; U.S. Pat. No. 2,001,869, issued to Deniston on May 21, 1935; U.S. Pat. No. 2,046,837, issued to Phillips on Jul. 7, 1936; U.S. Pat. No. 2,075,411, issued to Mertens on Mar. 30, 1937; U.S. Pat. No. 2,093,610, issued to Kraemer on Sep. 21, 1937; U.S. Pat. No. 2,190,883, issued to Pauze on Feb. 20, 1940; U.S. Pat. No. 2,269,708, issued to Dickson on Jan. 30, 1942; U.S. Pat. No. 2,558,379, issued to Phipard on Jun. 26, 1951; U.S. Pat. No. 2,605,867, issued to Goodwin on Aug. 5, 1952; U.S. Pat. No. 2,967,448, issued to Hallock on Jan. 10, 1961; U.S. Pat. No. 3,010,353, issued to Psaros on Nov. 28, 1961; U.S. Pat. No. 3,019,460, issued to Corckram on Feb. 6, 1962; U.S. Pat. No. 3,056,234, issued to Nelsson et al. on Oct. 2, 1962; U.S. Pat. No. 3,204,516, issued to Wieber on Sep. 7, 1965; U.S. Pat. No. 3,850,073, issued to Hayes on Nov. 26, 1974; U.S. Pat. No. 3,861,527, issued to Perkins on Jan. 21, 1965; U.S. Pat. No. 3,977,142, issued to Dove et al. on Aug. 31, 1976; U.S. Pat. No. 4,572,720, issued to Rockenfeller et al. on Feb. 25, 1986; U.S. Pat. No. 4,718,802, issued to Rockenfeller, et al. on Jan. 12, 1988; U.S. Pat. No. 4,932,820, issued to Schniedermeier on Jun. 12, 1990; U.S. Pat. No. 5,375,957, issued to Golledge on Dec. 27, 1994; and U.S. Pat. No. 5,741,104, issued to Lat et al. on Apr. 21, 1998. Each of these patents is hereby expressly incorporated by reference in its entirety. These prior art references teach that screws should cut the wood fibers with a cutting or pyramid shaped point during insertion. Thus, it may be seen that these prior art patents are very limited in their teaching and utilization, and an improved impact driveable screwnail is needed to overcome these limitations.

### SUMMARY OF THE INVENTION

The present invention is directed to an improved screw nail, the use of an elastomer seal in combination with the screw nail, the teaching of a collating web allowing the use of the screw nail and seal in a collated web fed pneumatic nail gun or impact driver and the use of a highlighted tip for low light or tight installation areas.

In accordance with one exemplary embodiment of the present invention, an asymmetric thread impact drivable screw is provided using an impact head and a conical shaped tip having a ballistic insertion angle formed on the ends of a shank defining an axis. Of particular note is the use of the ballistic tip with the shank defining asymmetrical threads. The ballistic tip and the threads have a unique shape adapted for dividing the wood fibers while minimizing the cutting or breakage of the wood fibers. The thread has an insertion flank protruding from the shank at slide angle to push the fibers aside and allow for penetration of the wood without cutting the fibers. The slide angle has a long surface area leading to a crest that is supported on the back side by a catch flank. The catch flank is protruding from the shank at an impact supporting grip angle that provides the necessary support to the crest during impact insertion while still providing increased gripping strength when compared to bare nail shanks. In yet a further embodiment, the use of mushroom compaction threads are also disclosed. In another embodiment, the screws nails are collated into a clip for use with an impact fastener such as a pneumatic or gas operated nail gun.

In another embodiment, the present invention teaches the use of an elastomer seal in combination with the screw nail to puncture and seal during installation. The present invention was developed for use with metal siding, but has many applications where sealing is required. In addition to the seal, the present invention teaches the use of a collating web with offset fingers to remove the possibilities of seal contaminants and to allow for web to nail separation without harm to the elastomer seal during the use of a pneumatic or other impact nailing gun.

A still further invention is the teaching of a highlighted tip for accurate placement in low light or tight hole installations.

These and other objects and advantages of the present invention, along with features of novelty appurtenant thereto, will appear or become apparent by reviewing the following detailed description of the invention.

### BRIEF DESCRIPTION OF THE SEVERAL VIEWS OF THE DRAWINGS

In the following drawings, which form a part of the specification and which are to be construed in conjunction therewith, and in which like reference numerals have been employed throughout wherever possible to indicate like parts in the various views:

FIG. 1 is a top view of a screwnail showing a Phillips head.

FIG. 2 is a side view of a screwnail showing the ballistic point and unique thread configuration.

FIG. 3 is an enlarged view of the unique thread configuration showing the elongated slide flank and the crest angle supported by the grip flank.

FIG. 4 is a top view of a screwnail showing a square drive head.

FIG. 5 is a side view of a screwnail showing the ballistic point, non-threaded shaft section and unique thread configuration.

FIG. 6 is a top view of a screwnail showing a slot head.

FIG. 7 is a side view of a screwnail showing the ballistic point, non-threaded shaft section and multiple thread sections.

FIG. 8 is a side view of a screwnail clip showing wire collating strips connecting multiple asymmetric thread screws using the unique thread configuration.

FIG. 9 is a side view of a screwnail clip showing plastic collating strips connecting multiple asymmetric thread screws using the unique thread configuration.

FIG. 10 is a side view of a screwnail showing a raised hex head.

FIG. 11 is a side view of a screwnail clip showing a paper collating strips connecting multiple asymmetric thread screws in a clipped head configuration.

FIG. 12 is a top view of a screwnail showing a clipped phillips head.

FIG. 13 is a top view of a screwnail showing a square drive head.

FIG. 14 is a side view of a screwnail showing the ballistic point, unique thread configuration, mushroom compaction threads, and driving head.

FIG. 15 is a cutaway view of a board with a mushroom compaction slide thread screwnail installed.

FIG. 16 is a cutaway view of a board with a mushroom compaction slide thread screwnail installed and showing the opposite side and the resulting hole in the composite.

FIG. 17 is a cutaway view showing a elastomeric seal on a screwnail before puncturing a steel substrate.

FIG. 18 is a cutaway view showing a elastomeric seal on a screwnail after puncturing a steel substrate.

FIG. 19 is a cutaway view showing a elastomeric seal on a screwnail sealing inside the puncture.

FIG. 19 is a cutaway view showing a elastomeric seal on a screwnail sealing inside the puncture and at the bottom of the indentation.

FIG. 20 is a cutaway view showing a elastomeric seal on a screwnail sealing inside the puncture, at the bottom of the indentation, and at the top of the indentation.

FIG. 21 is a cutaway view showing a elastomeric seal on a screwnail sealing inside the puncture, at the bottom of the indentation, at the top of the indentation, and on the top surface of the substrate.

FIG. 22 is a cutaway view showing an elastomeric seal on a screwnail performing all of the seals and showing how rim compression does not affect the internal seal because of the hollow head.

FIG. 23 shows the elastomeric seal screwnail on a finger collating strip.

FIG. 24 shows the elastomeric seal screwnail on a finger collating strip sliding against the finger.

FIG. 25 shows the elastomeric seal screwnail on a finger collating strip with the fingers sliding past the elastomer and releasing the shank.

FIG. 26 shows the elastomeric seal screwnail on a finger collating strip with the top finger released.

FIG. 27 shows the elastomeric seal screwnail on a finger collating strip with both fingers released and the bottom finger sliding past the elastomer.

FIG. 28 shows the elastomeric seal screwnail released from the collating strip.

FIG. 29 shows the unfolded collating strip before screw installation.

FIG. 30 shows a perspective view of the fasteners in the collating strip.

### DETAILED DESCRIPTION OF THE INVENTION

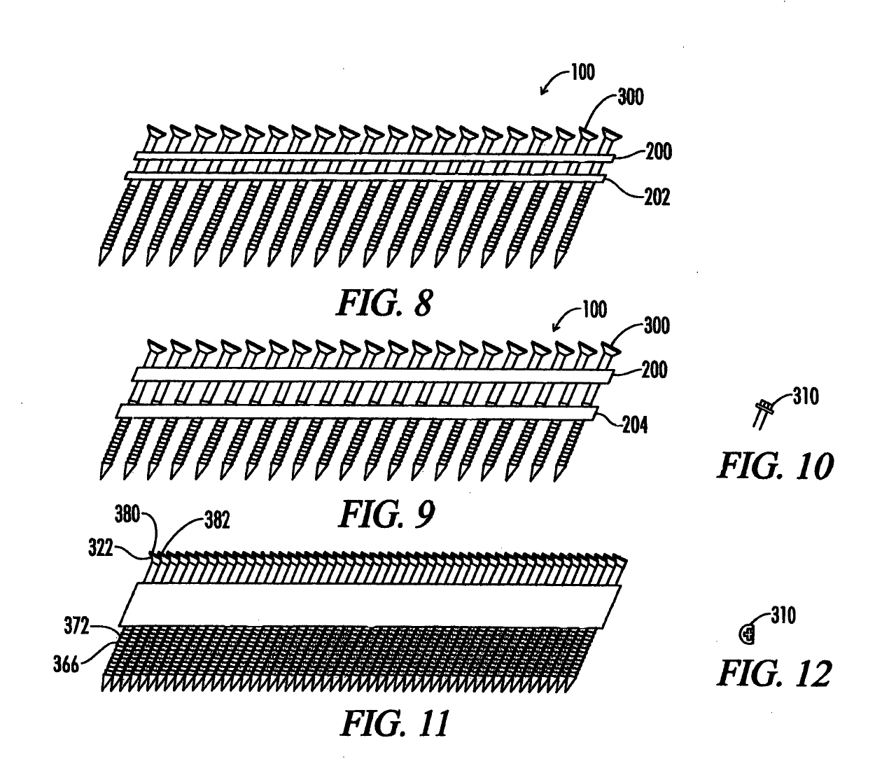

As shown in FIGS. 8 and 9 of the drawings, exemplary embodiments of the present invention are generally shown as an asymmetric thread impact drivable screw clips 100 having asymmetric thread impact drivable screws 300 connected by a collating strip 200. The collating strip 200 may be made from any conventional material including wire, paper, plastics, epoxies, or other known materials and is typically made from a wire 202 as shown in FIG. 8, or a plastic strip 204 as shown in FIG. 9. Strips, sheets, lines, and other known collating schemes may be used with the present invention. Alternative embodiments may include coiled strips, ratcheting strips, or other constructions.

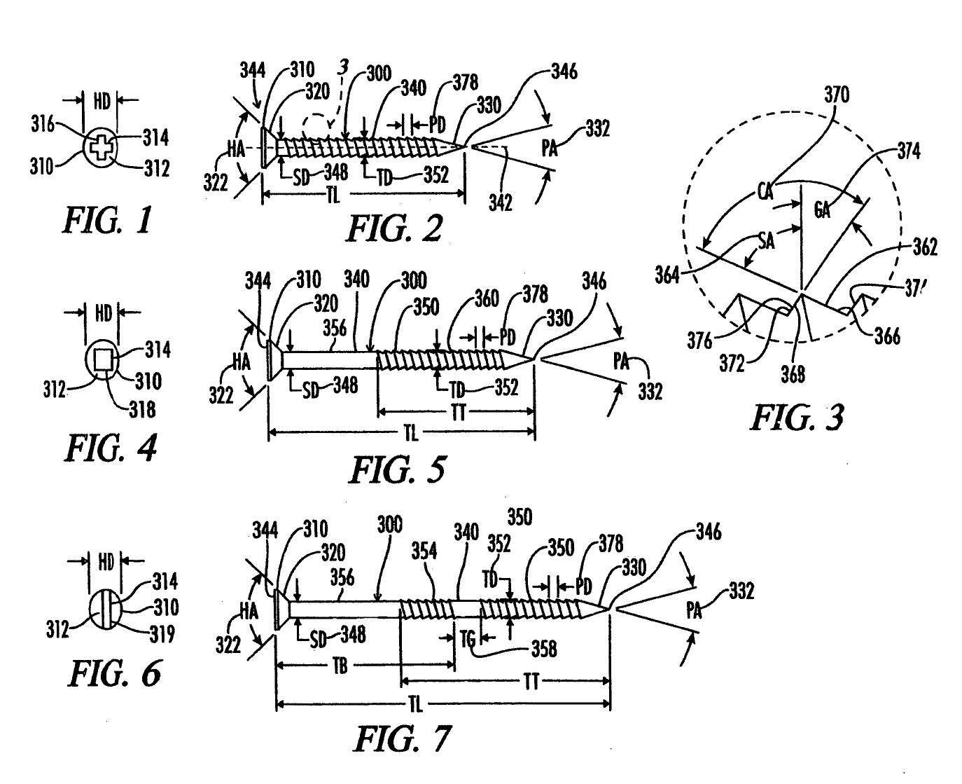

As shown in FIGS. 1 through 9, the asymmetric thread impact drivable screw 300 has an impact head 310 with a top surface 312 having a head diameter HD defining a tool receiving recess 314. The counter sunk head shown is the preferred design, although any of the other head types may be implemented if it is compatible with the type of impact tool being utilized. FIG. 1 shows a number two phillips aperture 316, FIG. 4 shows a number two square aperture 318, and FIG. 6 shows a slot aperture 319 which are the preferred shapes. Any type of tool receiving recess or bolt head design may be used that will fit in the area of top surface 312 and this design aspect will be dependent upon the contact head inside the impact driver. Most impact drivers use a flat driving hammer such that the design of the impact head may be varied according to the application.

For the preferred embodiment, the impact head 310 is connected with a tapered neck.320 to the shank 340. The tapered neck has a head neck angle HA 322 used for the countersinking of the impact head 310 to the surface of the material that the screwnail is being used to secure.

The opposite end of the shank 340 ends in a conical shaped tip 330 using a ballistic insertion point angle PA 332. The present invention teaches a unique distinction over the prior art teaching of diamond or cutting shaped screw point because a ballistic tip 330 is used to separate fibers with minimal or no cutting of the wood fibers. This allows the present invention to work in a variety of situations, including but not limited to wood to wood, wood to light gauge steel, drywall to wood, drywall to steel, foam to wood, foam to steel, subfloor attachment, roof deck attachment, siding attachment, concrete board attachment, fiberboard attachment, fencing applications, deck boards, framework, crating construction, pallet construction, soffit installation, concrete forms and other assemblies.

The shank 340 defines a central axis 342 running from the head end 344 to the tip end 346. The distance form the top of the impact head 310 to the bottom of the tip 330 is shown as the total length TL. The shank 340 defines a shank diameter SD 348 has at least a first threaded section 350 defining a major thread diameter TD 352. Multiple thread sections may be used as shown by the second threaded section 354 where the first section 350 and the second section 354 are separated by a thread gap TG 358. The top of the first thread is shown as the top thread TT measurement in FIGS. 5 and 7. The bottom of the first thread is shown as the thread bottom TB measurement in FIG. 7. The shank 340 may also define a non-threaded shank section 356.

A key aspect to the present invention is the use of the ballistic point 330 to separate the wood fibers along with the use of asymmetrical threads 360 using a low angle thread pitch 378 which passes the wood fibers with minimal or no tearing of the wood fibers. The asymmetric thread design and the fine thread shown by the pitch depth PD of the present invention keeps the wood fibers spread during insertion of the fastener without the large movements caused by changes between the maximum thread diameter and the root diameter of the thread. Thus, the relative high insertion speed consistency of the external shape of the present invention minimizes the cutting of the wood fibers during installation. The insertion without cutting is provided by a slide insertion flank 362 oriented at a slide angle SA 364 with a long slide surface 366 leading to the crest 368. The slide angle SA is shown in FIG. 3 as measured from a perpendicular line to the axis. This allows the wood fibers to be moved to the side without cutting into the fibers with the threads and the fine thread of the pitch depth keeps the fibers there without any substantial additional damage. Once the high speed insertion is stopped, the fibers will then close around the back side of the crest angle CA 370 and are caught by the grip catch flank 372 oriented at an impact supporting grip angle GA 374 providing a short catch surface 376. Note that the grip angle GA 374 must be chosen so that the grip catch flank 372 can provide the necessary strength to the crest 368 during the high impact forces of ballistic insertion while still providing an increased grip for the grip catch flank 372. This slide angle SA 364, grip angle GA 374 and crest angle CA 370 allow for increased holding power while minimizing or eliminating cutting of the wood fibers. The elongated nature of the wood fibers increases the holding power of the wood to screw connection to provide a superior product over previously known designs. A further advantage is provided by the fine thread and limited damage design of the present invention because removal of the screwnail leaves a smooth hole like a nail removal instead of a torn hole that is created by a prior art type of cutting screw. Typical design parameters are shown in the following table:

| | Descr. | General | General | General |
|---|---|---|---|---|
| | Type | .113 (inch) * L | .120 (inch) * L | .131 (inch) * L |
| HD | Head diameter | 7.0 ± | 7.0 ± | 7.0 ± |
| | | 0.15 mm | 0.15 mm | 0.15 mm |
| HA | Head Angle | 80° ± | 80° ± | 80° ± |
| | | 2° | 2° | 2° |
| PA | Point angle | 28° ± | 28° ± | 28° ± |
| | | 5° | 5° | 5° |
| TL | Length | L ± | L ± | L ± |
| | | 1.27 mm | 1.27 mm | 1.27 mm |
| TB | First thread | Point | Point | Point |
| | bottom* | | | |
| TG | Thread Gap** | NA | NA | NA |
| TT | First Thread | 2/3*L | 2/3*L | 2/3*L |
| | Top*** | | | |
| PD | Pitch Distance | 1.59 ± | 1.69 ± | 1.69 ± |
| | | 10% mm | 10% mm | 10% mm |
| SD | Shank | 2.87 ± | 3.05 ± | 3.33 ± |
| | Diameter | 0.03 mm | 0.03 mm | 0.03 mm |
| TD | external thread | 3.15 ± | 3.43 ± | 3.70 ± |
| | diameter | 0.05 mm | 0.05 mm | 0.05 mm |
| SA | Slide Angle | 70° ± | 70° ± | 70° ± |
| | | 2° | 2° | 2° |
| GA | Grip Angle | 40° ± | 40° ± | 40° ± |
| | | 2° | 2° | 2° |
| CA | Crest Angle | 110° ± | 110° ± | 110° ± |
| | | 2° | 2° | 2° |
| | Head type | #2 phillips or | #2 phillips or | #2 phillips or |
| | | square | square | square |
| | Material | c-1010 or 1022 | c-1010 or 1022 | c-1010 or 1022 |
| | | steel | steel | steel |
| | Surface | Hv450 Min | Hv450 Min | Hv450 Min |
| | hardness | | | |
| | Case Depth | 0.05 mm Min | 0.05 mm Min | 0.05 mm Min |
| | Bending angle | 12° Min | 12° Min | 12° Min |
| | Torsional | 28 kg/cm Min | 35 kg/cm Min | 45 kg/cm Min |
| | Strength | | | |
| | Coating | 3um | 3um | 3um |

*measured from head
**measured from first thread bottom to second thread top
***measured from ballistic point

The preferred embodiments use the following design parameters:

| | Descr. | Example | Example | Example | Example | Example | Example |
|---|---|---|---|---|---|---|---|
| | Type | .113 (inch) * | .113 (inch) * | .113 (inch) * | 2.85 (inch) * | 2.85 (inch) * | 2.85 (inch) * |
| | | 1.5 (inch) | 2.0 (inch) | 2.5 (inch) | 2 (inch) | 2.5 (inch) | 3 (inch) |
| HD | Head diameter | 6.83 ± 0.15 mm | 6.83 ± 0.15 mm | 6.83 ± 0.15 mm | 6.1 ± 1 mm | 6.1 ± 1 mm | 6.1 ± 1 mm |
| HA | Head Angle | 80° ± 2° | 80° ± 2° | 80° ± 2° | 80° ± 2° | 80° ± 2° | 80° ± 2° |
| PA | Point angle | 28° ± 5° | 28° ± 5° | 28° ± 5° | 28° ± 5° | 28° ± 5° | 28° ± 5° |
| TL | Length | 38.1 ± 1.27 mm | 57.15 ± 1.27 mm | 63.5 ± 1.27 mm | 57.15 ± 1.27 mm | 63.5 ± 1.27 mm | 76.2 ± 1.27 mm |
| TB | First thread bottom * | Point | 34.5 ± 1.0 mm | 34.5 ± 1.0 mm | Point | Point | Point |
| TG | Thread Gap ** | NA | 5.0 ± 0.5 mm | 5.0 ± 0.5 mm | NA | NA | NA |
| TT | First Thread Top *** | Head | 35 ± 1.0 mm | 40 ± 1.0 mm | 30 ± 1.0 mm | 42 ± 1.0 mm | 442 ± 1.0 mm |
| PD | Pitch Distance | 1.59 ± 10% mm | 1.59 ± 10% mm | 1.59 ± 10% mm | 1.59 ± 10% mm | 1.59 ± 10% mm | 1.59 ± 10% mm |
| SD | Shank Diameter | 2.87 ± 0.03 mm | 2.87 ± 0.03 mm | 2.87 ± 0.03 mm | 2.87 ± 0.03 mm | 2.87 ± 0.03 mm | 2.87 ± 0.03 mm |
| TD | external thread | 3.15 ± 0.05 mm | 3.15 ± 0.05 mm | 3.15 ± 0.05 mm | 3.15 ± 0.05 mm | 3.15 ± 0.05 mm | 3.15 ± 0.05 mm |
| | diameter | | | | | | |
| SA | Slide Angle | 70° ± 2° | 70° ± 2° | 70° ± 2° | 70° ± 2° | 70° ± 2° | 70° ± 2° |
| GA | Grip Angle | 40° ± 2° | 40° ± 2° | 40° ± 2° | 40° ± 2° | 40° ± 2° | 40° ± 2° |
| CA | Crest Angle | 110° ± 2° | 110° ± 2° | 110° ± 2° | 110° ± 2° | 110° ± 2° | 110° ± 2° |
| | Head type | #2 phillips | #2 phillips | #2 phillips | #2 phillips | #2 phillips | #2 phillips |
| | | or square | or square | or square | or square | or square | or square |
| | Material | c-1010 or 1022 | c-1010 or 1022 | c-1010 or 1022 | c-1010 or 1022 | c-1010 or 1022 | c-1010 or 1022 |
| | | steel | steel | steel | steel | steel | steel |
| | Surface hardness | Hv450 Min | Hv450 Min | Hv450 Min | Hv450 Min | Hv450 Min | Hv450 Min |
| | Case Depth | 0.05 mm Min | 0.05 mm Min | 0.05 mm Min | 0.05 mm Min | 0.05 mm Min | 0.05 mm Min |
| | Bending angle | 12° Min | 12° Min | 12° Min | 12° Min | 12° Min | 12° Min |
| | Torsional Strength | 28 kg/cm Min | 28 kg/cm Min | 28 kg/cm Min | 28 kg/cm Min | 28 kg/cm Min | 28 kg/cm Min |
| | Coating | 3 um | 3 um | 3 um | 3 um | 3 um | 3 um |

* measured from head
** measured from first thread bottom to second thread top
*** measured from ballistic point

Obvious variations may be made to these examples, including varying the angles outside of these preferred parameters and changing thicknesses or types of coatings. For example, common requests for diameters of screws are 0.099, 0.100, and 0.105 inch diameter screws with varying lengths. Note that any type of coating may be used with this screw design including, galvanized coating, yellow zinc, paint, ceramic, concrete, etc. . . . Thus, these examples are illustrative only and are not meant to limit the present invention. A further example of this variation is shown in FIGS. 10, 11, and 12.

FIG. 10 shows how the head 310 may be varied to use a hex head or socket type of driver similar to the common one-quarter inch hex drives used in various industries. FIG. 11, shows a paper collation used on a D-head shaped impact head. Note that the head angle 322 has been changed from the preferred embodiment's eighty degree angle to a curvature to accommodate the adjacent heads. Further note should be taken in FIG. 11 of the advantages provided by the slide 366 and grip 372 configuration. As noted by FIG. 11, when screws are placed into a tight configuration such as with a full head, offset head, or clipped head configuration, the threads on the shanks of the screws may contact due to mishandling of the screw strip on the job site. With the present invention's slide 366, the threads of the driven screw 380 will not catch the threads of the adjacent screw 382 remaining on the strip because the slide 366 will guide the driven screw 380 past the adjacent screw 382. FIG. 12 shows a top view of the d-shaped clipped head 310. Note that full head, offset head, or clipped heads may be utilized as appropriate. From this, it may be seen that many variations may be utilized with the advantages taught by the present invention.

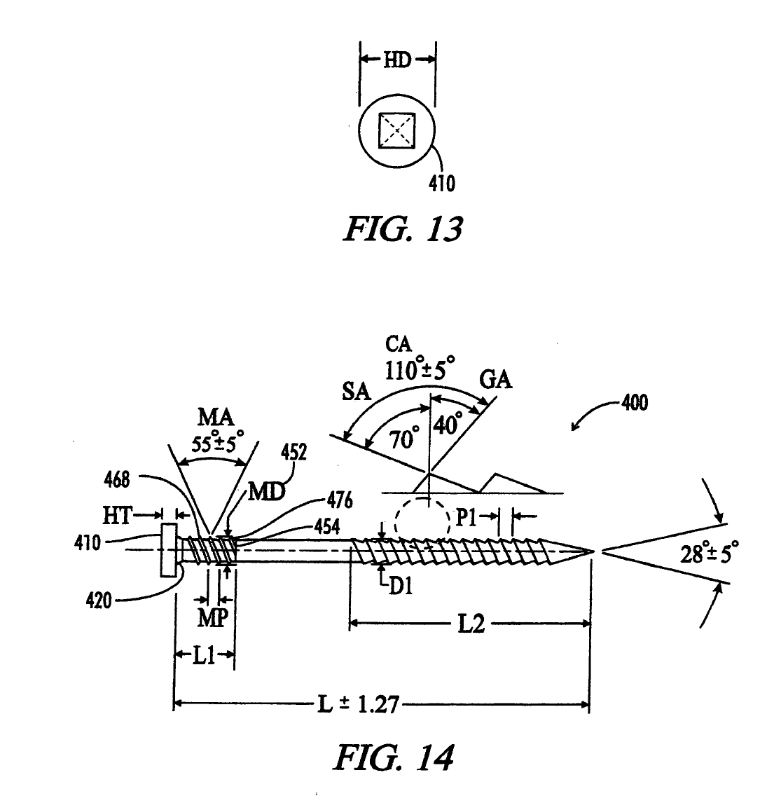

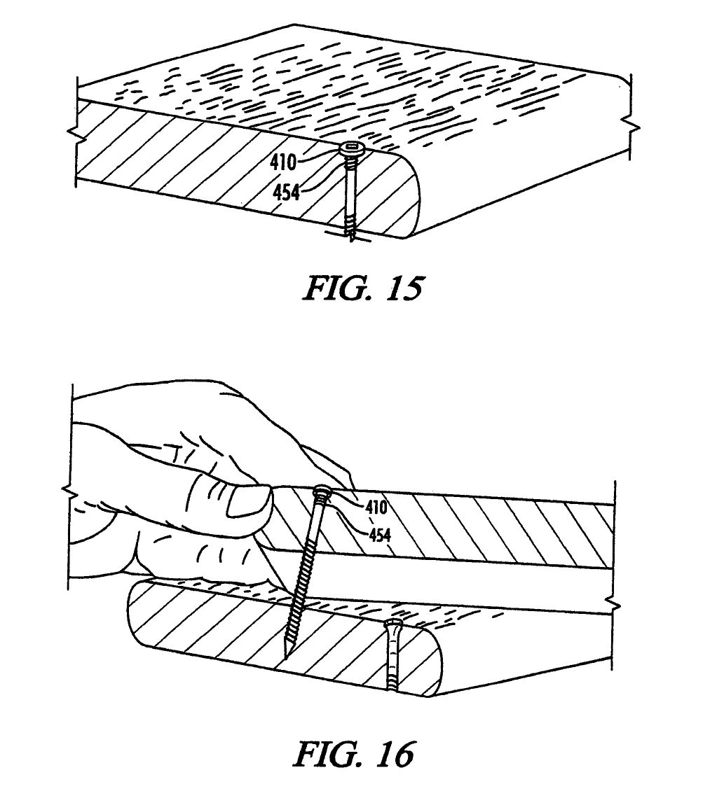

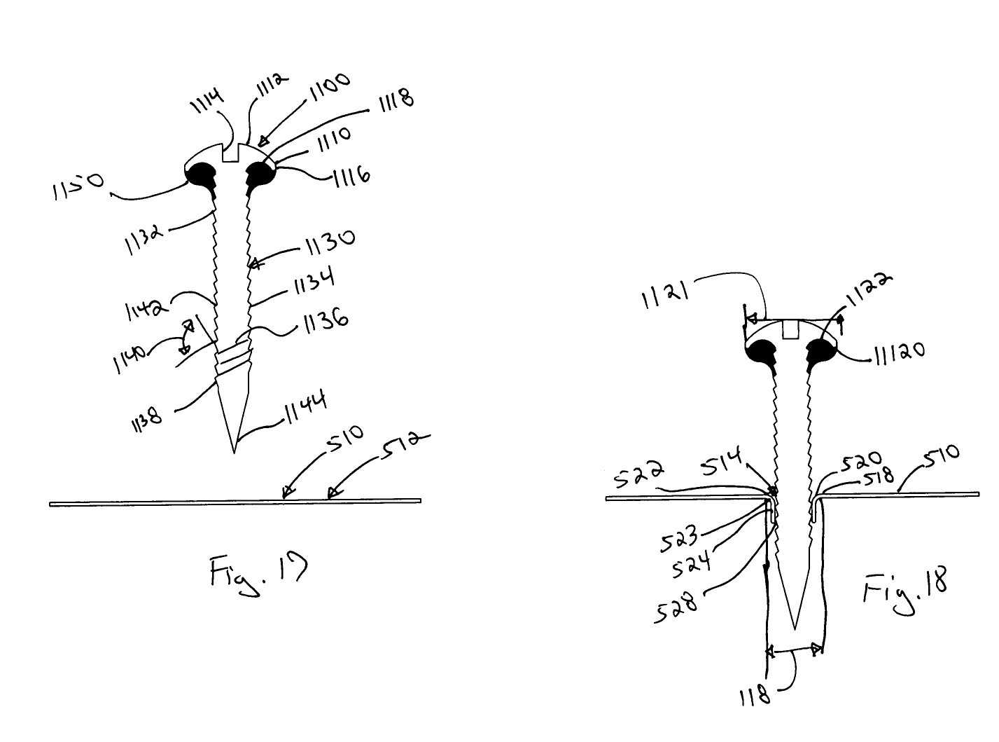

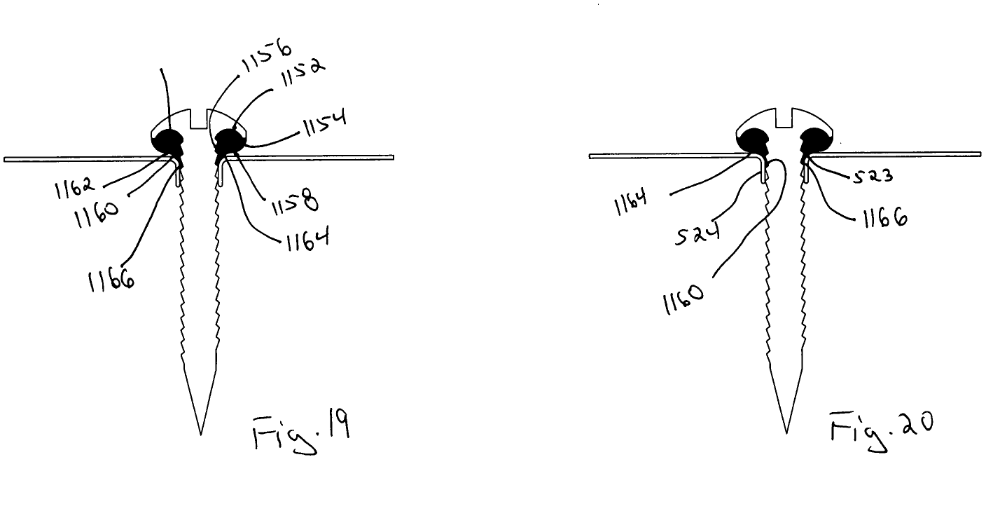

FIGS. 13, 14, 15, and 16 show the top and side views of a mushroom compaction asymmetric thread impact drivable screw 400. This mushroom compaction screw 400 uses a mushroom compaction impact head 410 having a similar top surface 312 and tool receiving recess 314 that can define a phillips aperture 316, a square aperture 318, a slot aperture 319, or other appropriate tool connection shape. Instead of the tapered neck 320, the mushroom compaction head is almost a blunt connection using only a minimal neck fillet 420. This allows for the capturing of any mushrooming wood fibers without the redirecting that would be caused by the tapered neck 320. Once again, a conical shaped tip 330 is used with a ballistic insertion angle 332 on the end of the shank 340. The shank 340 again defines the central axis 342 and the head end 344 and the tip end 346. Note head that in addition to the shank diameter 348 and the first threaded section 350 with the major thread diameter 352, there is second threaded section 354 with mushroom compaction threads 454 having a mushroom compaction diameter 452. A non-threaded shank section 356 can still be used with a thread gap 358.

The mushroom compaction threads 454 use either asymmetric or symmetrical threads 360 with a gripping insertion flank 462 leading to a crest 468 with a corresponding grip catch flank 472. In this manner, both the first and second sides of the threads 454 have a short catch surface 476. This allows for any mushrooming effect from the hole to be caught by the insertion side of the mushroom compaction threads 454 and pulled down into the hole to leave a smooth surface on the board.

Dimensions for the preferred embodiment of the mushroom compaction asymmetric thread impact drivable screw 400 are as follows:

| Head | Size | HD | MP ± 10% | P1 ± 10% | MD | D1 | L1 | L2 | HT |
|---|---|---|---|---|---|---|---|---|---|
| #2 Sq. | .120*L | 6.68~6.99 | 1.41 | 1.69 | 4.06~4.18 | 3.43 ± 0.05 | 5.5 ±1.0 | 40 ± 2.0 | 2 ± 0.1 |

The overall crest angle from the mushroom threads is 55°±5° symmetrically divided and the overall length is 2.25 inches. The ballistic angle, crest angle, slide angle and grip angle are as previously described. The material is c-1018 or 1022 steel with a surface hardness of Hv450 minimum and a case depth of 0.05 mm minimum. The bending angle is 12° Min with a torsional strength of 35 kg/cm minimum. Note that the mushrooming threads are comparatively short in length in this application due to the minimal, if any, mushrooming associated with the slide angle type of threads. This allows for use of the impact screw with most nail guns by allowing the penetration and holding power to be developed by the sliding threads with only the slight amount of compression used by the limited mushroom controlling threads. This allows for screw applications with the mushrooming control while still working in the limited capabilities of common impact drivers.

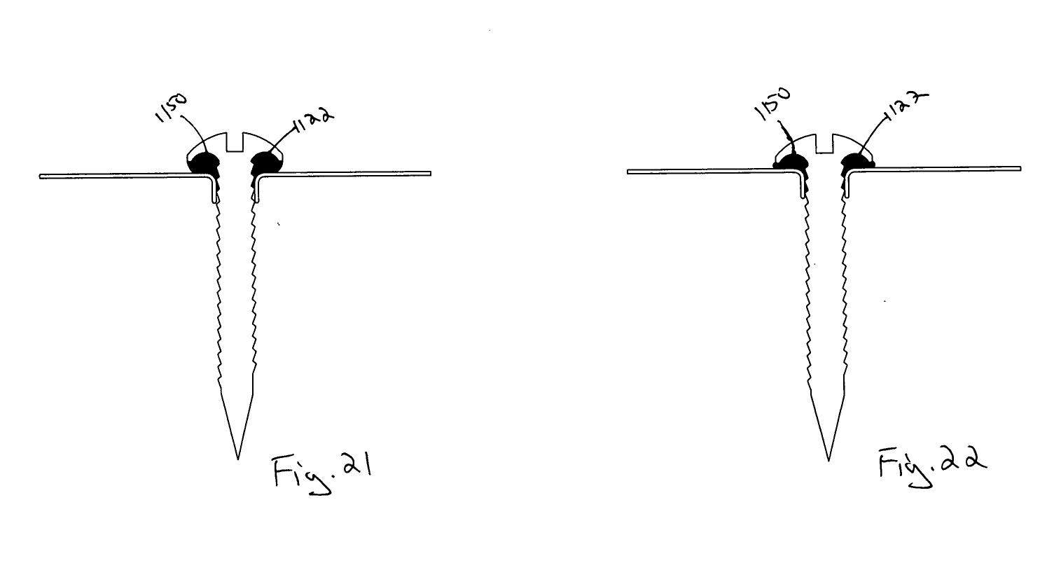

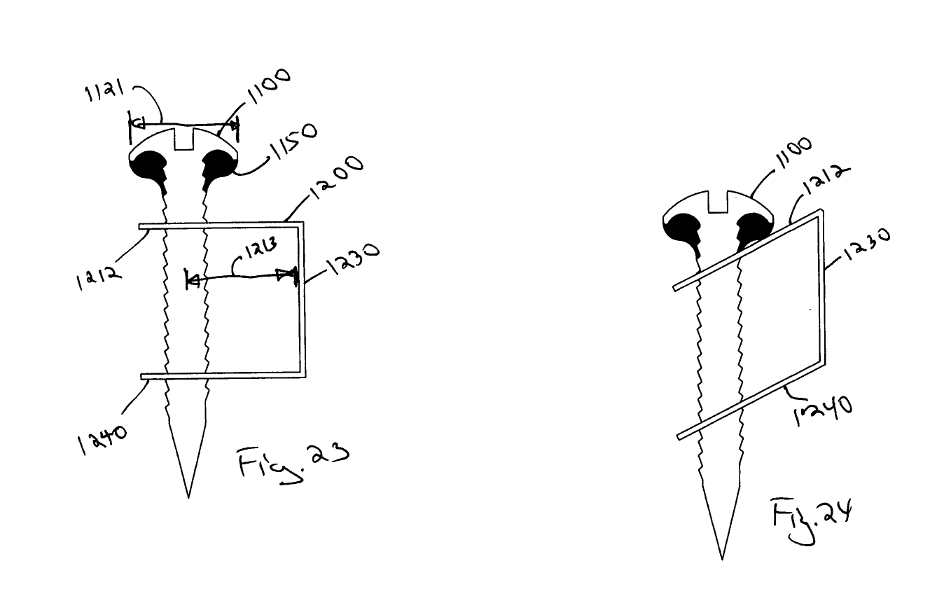

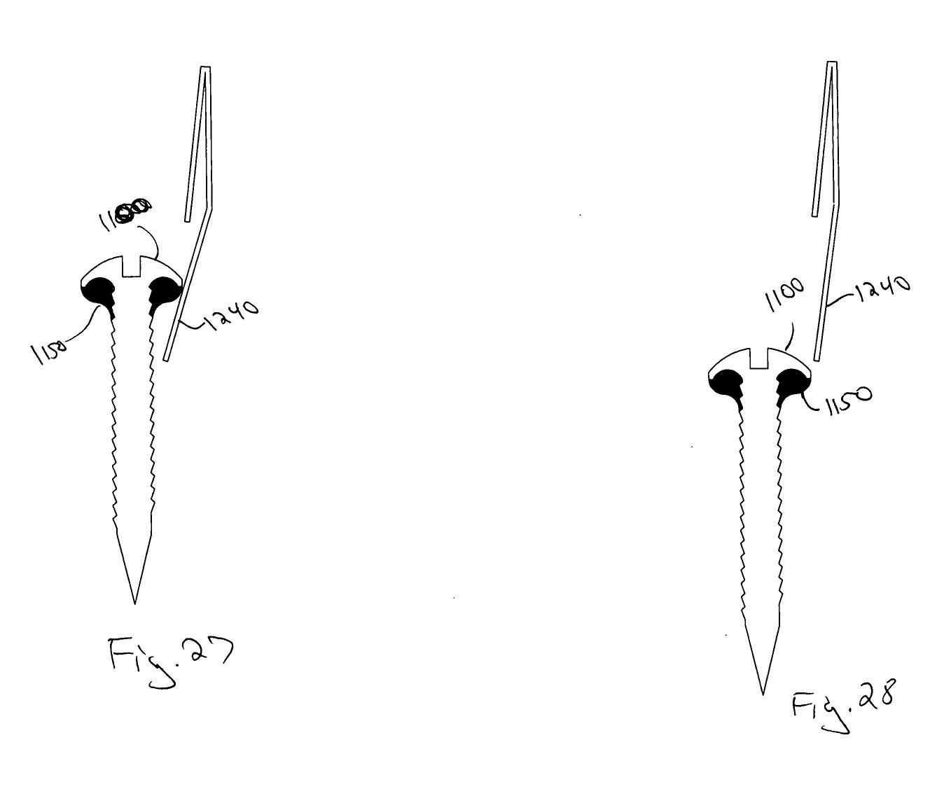

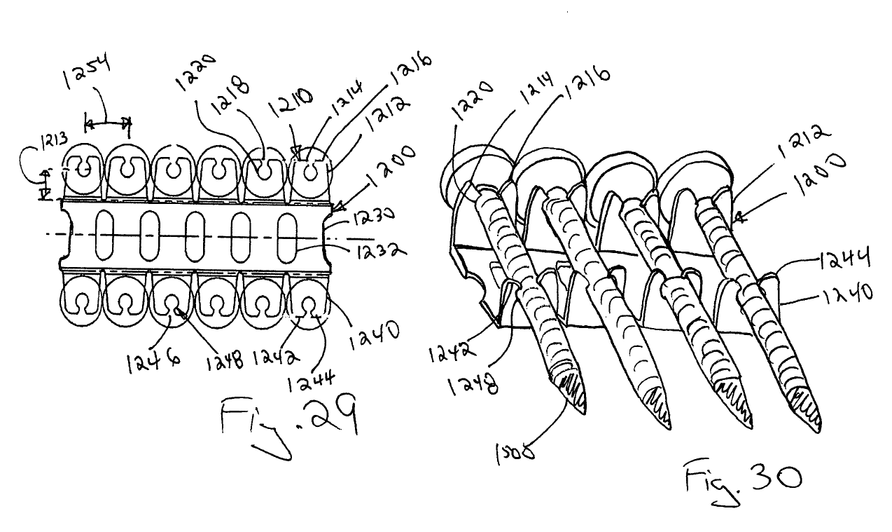

As shown in FIGS. 17-28 of the drawings, another portion of the present invention is directed to a further improvement in which a pointed fastener is adapted to pierce a substrate and then seal to the substrate. This is typically used on metal siding or roofing for buildings.

Generally, the substrate 510 has an upper surface 512 that is pierced by the fastener to form a hole 514 with a bore 526. The hole 514 begins at the upper surface 512 and includes a proximate upper surface area outside diameter 518 that is substantially flat leading into a substantially conical curving upper reduction 520 beginning with a substantially parallel section 522 and transitioning to an angled reduction 523 and then a substantially perpendicular section 524 leading to the penetrating aperture 528. The substantially parallel 522, angled reduction 523, and substantially perpendicular 524 references are viewed in reference to the upper surface 512.

The sealing fasteners 1100 include a head 1110 having a top surface 1112 defining a turning aperture 1114 such as a slot for a flat edge screwdriver, a T shape for a Phillips screwdriver or a square hole for a square drive. The top surface extends to an edge 1116 that curves around to a bottom surface 1118. The bottom surface 1118 has an outer compression face 1120 and an interior concave shape forming a compression cavity 1122. The diameter 1121 of the compression face should be larger than the distance across the outside diameter 118 of the upper reduction 520. With the new design of this fastener the compression face distance is not critical for sealing, as it was in past devices, but is important for pull-through holding power on thin wall sheathing material. If the substrate is strong enough, then this diameter may also be reduced to obtain flush mounting fasteners while still maintaining a seal with the present invention. Below the head 1100 is the shank 1130 that starts at the neck end 1132 that is attached to the head 1110. The neck end 1132 is attached to the body 1134 that connects to the tip end 1144. The body 1134 defines threads 1136 having an insertion flank 1138, a crest angle 1140, and a catch flank 1142. The dimensions and construction for these items are fully disclosed in the previous discussion and the applications that are incorporated into this application.

The sealing aspect of the present invention uses an elastomer seal 1150 with multiple sections or components that work with the rigid connection of the fastener 1100. The elastomer seal 1150 includes a head sealing surface 1152 and a neck sealing surface 1156 to seal to the fastener. In the present embodiment, the elastomer seal is wet formed on the fastener so that it is bonded onto the fastener in a sealable manner at all times. Once dried, the elastomer seal defines a compression edge 1154 at the outer compression face 1120 and a parallel sealing surface 1158 that is adapted to form a first or outermost seal on the upper surface. This exterior compression edge seal is similar to the type of seal that was achieved in the prior art where a washer was placed on a nail and the nail head was used to compress the washer against the surface to obtain the seal. Thus, while the placement of a compression seal at this location is not considered new based on the prior art's use of a nail head and a rubber washer, the use of a elastomer on the fastener that is bonded or already sealed to the underside of the head of the fastener is considered novel.

Next, we note that the washers of the prior art would typically have an inside diameter larger than or approximating the size of the shank of the nail. Thus, the washer relied on the seal to the head of the nail and failed to provide a proper seal to the shaft of the nail. The present invention addressed this problem by using a neck sealing surface 1156.

The lower part of the elastomer seal 1150 defines an inner conically descending lower seal 1160 defining a thick upper edge 1162 connected to a diametrically reducing central body 1164 and a lower fillet 1166. This provides additional seals are additional areas in case the first or outermost diameter surface to head seal fails. Here, it is important to understand the shape of the upper reduction 520 and how it transforms from the initial surface parallel reduction 522 through the angled reduction 523 to the surface perpendicular reduction 524. In the prior art use of washers, only the outermost section of the washer would be used to seal against the nail head because as you go towards the nail shank, the expanding distance between the nail head and the initial surface parallel reduction 522 caused in the surface by the fastener penetration would not provide the proper compression forces to seal the prior art washer. In contrast to this, the present invention uses the thick upper edge 1162 of the bonded or sealed elastomer with the concave head shape of the fastener to provide sufficient material to flow or mold into the upper reduction 520 and be compressed against the initial surface parallel reduction 522. This provides a seal at the initial surface parallel reduction 522 of the upper reduction 520.

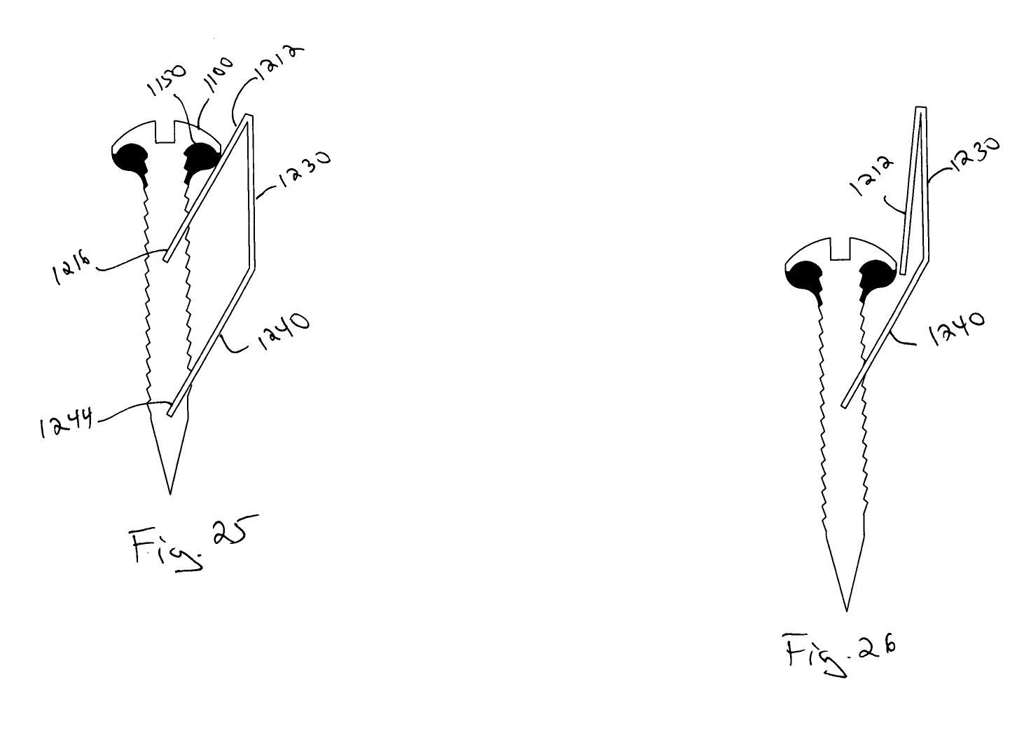

The next sealing area is formed with the diametrically reducing central body 1164 acting against both the angled reduction 523 and the perpendicular reduction 524. In contrast to the flat planar washer of the prior art that only sealed against the surface, the present invention teaches a three dimensional shape for the diametrically reducing central body 1164. This allows for the diametrically reducing central body 1164 to seal against the angled reduction 523 and then also seal against the perpendicular reduction 524. In this manner, the hole is also sealed and not just the outer surface. This allows for improved sealing, even when the fastener is driven at an angle, or is not completely driven against the surface. Thus, the present invention provides for improved sealing capabilities over the prior art. FIG. 21 shows how the neck seal is formed, and FIG. 22 shows how both the neck seal and the compression seal are formed. Note in FIG. 22 how the hollow head contour allows for the proper compression to be maintained on the sealing material even through the outside ring compression forces may be over driven.

Finally, the formation of the lower fillet 1166 is used to act as a force dispersant for the molding forces acting on the lower seal 1160. This improves the lower seal's ability to withstand the forces operating on this area. This can be contrasted against a perpendicular construction. Instead of a force concentration area that would be formed at the perpendicular bonding of the elastomer to the shank 1130, the present invention prefers to use a lower fillet 1166 to spread these forces out over a larger area to use the elastomeric properties to absorb these forces.

As shown in FIGS. 23-30, another improvement of the present invention is the application of the elastomer 1150 in combination with the collated strip for installation using a pneumatic nail gun. In this embodiment, a collated strip of removable impact fasteners is provided with a dry surface compressing elastomer gasket sealably adhered to the fastener, that allows for installation by a pneumatic gun without disturbing the integrity of the elastomer or causing particulate matter to become trapped in the sealing area.

In order to maintain the integrity of the elastomer seal during the power driving process, care must be taken not to tear or harm the seal when it is released from the collating element. The standard shaft position collation of the prior art using strips of paper, plastic, and/or wire collating along with overlapping heads can cause problems in tearing or damaging the elastomer during installation, or breaking or tearing the collating medium into pieces that end up getting captured by the head and forced down into the sealing area. Thus, for the present invention a collating strip 1200 was designed to overcome the limitations of the prior art. The collating strip 1200 includes a gripping connection 1210 using an upper clip 1212, a body 1230, and a lower clip 1240 for each of the fasteners. The upper clip 1212 includes a first upper opposing finger 1214 and second upper opposing finger 1216 forming an upper insertion mouth 1218 and upper fastener gripping aperture 1220 to grip and capture the fastener. Note that the upper clip length 1213 which is the distance from the fastener gripping aperture to the body 1230 is important to place the body at a distal position greater than the diameter 1121 of the compression face 1120. With this construction, the smooth clips 1212, 1240 will pivot to slide past the elastomer seal 1150 during installation.

The body 1230 is preferably constructed with a body lightening aperture 1232 although a solid construction may be used if desired. The body supports a lower clip 1240 with a first lower opposing finger 1242 and second lower opposing finger 1244 forming a lower insertion mouth 1246 and lower fastener gripping aperture 1248. In between the upper clip 1212 and lower clip 1240 is a spacing web 1250 which may also include a spacing lightening aperture 1252. In the preferred embodiment, the spacing web 1250 has a length 1251 greater than the fastener head diameter 1254 so that painted fasteners do not touch or rub during shipment and installation.

Another improvement of the present invention is the plating or painting of the nail tips for high visibility when being installed into recessed or dark areas. Because of shading, the dark nature of nail guns, and shadows inevitably cast during the various positions of the operator during construction, the present invention uses a highlight tip 1500 which is a reflective paint or white paint painted on the tip of the fastener. One paint that may be utilized is 3M™ ALL WEATHER PAINT, available from 3M Traffic Safety Systems, 3M Center, Building 235-3A-09, St. Paul, Minn. 55144-1000. It is desirable to use paints with reflective specks such as titanium or metal flakes. Additionally, a small light may be used to further enhance visibility of the highlighted tip by adding a simple LED light to the side of the pneumatic gun. A prototype was tried using this method with success. A small light like that used in the experiment is the ENERGIZER® High Tech LED Keychain Light available from ENERGIZER Headquarters, 533 Maryville University Drive, St. Louis, Mo. 63141. The light is attached using double sided tape to the side of the pneumatic gun in a position to allow for the light to shine on the highlight tip. It is also envisioned that a simple lighting circuit connecting the battery to the light with a resistor and a switch in series with the light could be implemented to connect the light to an onboard battery like those used in the combusting gas guns currently on the market.

Thus, it may be seen that the present invention provides an advantage over the prior art.

Reference numerals used throughout the detailed description and the drawings correspond to the following elements:
an asymmetric thread impact drivable screw clip 100
a collating strip 200
a wire 202
a plastic strip 204
an asymmetric thread impact drivable screw 300
an impact head 310
a top surface 312
a tool receiving recess 314
a phillips aperture 316
a square aperture 318
a slot aperture 319
a tapered neck. 320
a neck head angle 322
a conical shaped tip 330
a ballistic insertion angle 332
a shank 340
an axis 342
a head end 344
a tip end 346
a shank diameter 348
first threaded section 350
a major thread diameter 352
second threaded section 354
a non-threaded shank section 356
a thread gap 358
asymmetrical threads 360
a slide insertion flank 362
slide angle 364
a long slide surface 366
a crest 368
a crest angle 370
a grip catch flank 372
impact supporting grip angle 374
a short catch surface 376
thread pitch 378
driven screw 380
remaining screw 382
mushroom compaction asymmetric thread impact drivable screw 400
mushroom compaction impact head 410
neck fillet 420
mushroom compaction diameter 452
mushroom compaction threads 454
gripping insertion flank 462
crest 468
grip catch flank 472
short catch surface 476
Substrate 510
Upper surface 512
Hole 514
Shape 516
Outside diameter 518
Upper reduction 520
Parallel reduction 522
Angled reduction 523
Perpendicular reduction 524
Bore 526
Penetrating aperture 528
The sealing fasteners 1100
a head 1110
a top surface 1112
a turning aperture 1114
an edge 1116
a bottom surface 1118
a compression face 1120
a compression cavity 1122
diameter 1124
a shank 1130
a neck end 1132
a body 1134
threads 1136
insertion flank 1138
crest angle 1140
catch flank 1142
a tip end 1144
an elastomer seal 1150
a head sealing surface 1152
an compression edge 1154
a neck sealing surface 1156
a parallel sealing surface 1158
an inner conically descending lower seal 1160
thick upper edge 1162
a diametrically reducing central body 1164
a lower fillet 1166
A collating strip 1200
A gripping connection 1210
An upper clip 1212
First upper opposing finger 1214
Second upper opposing finger 1216
Upper insertion mouth 1218
Upper fastener gripping aperture 1220
A body 1230
A body lightening aperture 1232
A lower clip 1240
First lower opposing finger 1242
Second lower opposing finger 1244
Lower insertion mouth 1246
Lower fastener gripping aperture 1248
A spacing web 1250
A spacing lightening aperture 1252
A web spacing distance greater than the fastener head diameter 1254
Highlight tip 1500

From the foregoing, it will be seen that this invention is well adapted to obtain all the ends and objects herein set forth, together with other advantages which are inherent to the structure. It will also be understood that certain features and subcombinations are of utility and may be employed without reference to other features and subcombinations. This is contemplated by and is within the scope of the claims. Many possible embodiments may be made of the invention without departing from the scope thereof. Therefore, it is to be understood that all matter herein set forth or shown in the accompanying drawings is to be interpreted as illustrative and not in a limiting sense

When interpreting the claims of this application, method claims may be recognized by the explicit use of the word ‘method’ in the preamble of the claims and the use of the ‘ing’ tense of the active word. Method claims should not be interpreted to have particular steps in a particular order unless the claim element specifically referring to a previous element, a previous action, or the result of a previous action. Apparatus claims may be recognized by the use of the word ‘apparatus’ in the preamble of the claim and should not be interpreted to have ‘means plus function language’ unless the word ‘means’ is specifically used in the claim element. The words ‘defining,’ ‘having,’ or ‘including’ should be interpreted as open ended claim language that allows additional elements or structures.

What is claimed is:

1. A sealing fastener apparatus for piercing a substrate with an upper surface, the apparatus comprising:
a head, a shank and a tip, the tip adapted to pierce the upper surface to form a hole with a shape having an outside diameter, an upper reduction, and a bore,
a dry surface compressing elastomer gasket sealably adhered to the fastener and sealing against the outside diameter of the hole.

2. A sealing fastener apparatus for piercing a substrate with an upper surface, the apparatus comprising:
a tip adapted to pierce the upper surface to form a hole with a shape having an outside diameter, an upper reduction, and a bore,
a dry surface compressing elastomer gasket sealably adhered to the fastener and sealing against the upper reduction.

3. The apparatus of claim 2, the upper reduction including a substantially conical upper portion, an angled reduction, and a perpendicular reduction; and
a dry surface compressing elastomer gasket sealably adhered to the fastener and sealing against the substantially conical upper portion.

4. The apparatus of claim 2, the upper reduction including a substantially conical upper portion, an angled reduction, and a perpendicular reduction; and
a dry surface compressing elastomer gasket sealably adhered to the fastener and sealing against the angled reduction.

5. The apparatus of claim 2, the upper reduction including a substantially conical upper portion, an angled reduction, and a perpendicular reduction; and
a dry surface compressing elastomer gasket sealably adhered to the fastener and sealing against the perpendicular reduction.

6. A sealing fastener apparatus for piercing a substrate with an upper surface, the apparatus comprising:
a tip adapted to pierce the upper surface to form a hole with a shape having an outside diameter, an upper reduction, and a bore,
a dry surface compressing elastomer gasket sealably adhered to the fastener and sealing against the bore.

7. The apparatus of a claim 1, wherein upon removal of the fastener the dry surface elastomer seal is completely removed via the adherence to the fastener.

8. The apparatus of a claim 2, wherein upon removal of the fastener the dry surface elastomer seal is completely removed via the adherence to the fastener.

9. The apparatus of a claim 3, wherein upon removal of the fastener the dry surface elastomer seal is completely removed via the adherence to the fastener.

10. The apparatus of a claim 4, wherein upon removal of the fastener the dry surface elastomer seal is completely removed via the adherence to the fastener.

11. The apparatus of a claim 5, wherein upon removal of the fastener the dry surface elastomer seal is completely removed via the adherence to the fastener.

12. The apparatus of a claim 6, wherein upon removal of the fastener the dry surface elastomer seal is completely removed via the adherence to the fastener.

13. The apparatus of claim 1, further comprising: at least one collating strip connected to the shank.

14. The apparatus of claim 2, further comprising: at least one collating strip connected to the shank.

15. The apparatus of claim 3, further comprising: at least one collating strip connected to the shank.

16. The apparatus of claim 4, further comprising: at least one collating strip connected to the shank.

17. The apparatus of claim 5, further comprising: at least one collating strip connected to the shank.

18. The apparatus of claim 6, further comprising: at least one collating strip connected to the shank.

19. The apparatus of claim 13, wherein the collating strip is a plastic strip.

20. The apparatus of claim 1, the tip including a low light visibility enhancement.
